(19) United States
(12) Patent Application Publication
(10) Pub. No.: US 2021/0086588 A1
(43) Pub. Date: Mar. 25, 2021

(54) VALVE DEVICE

(71) Applicant: DENSO CORPORATION, Kariya-city (JP)

(72) Inventors: Shinji KAWADA, Kariya-city (JP); Seiji TATEISHI, Kariya-city (JP); Hikaru OTSUKA, Kariya-city (JP); Hiroto INOUE, Kariya-city (JP); Shin KUWATA, Kariya-city (JP); Tetsuya ITO, Kariya-city (JP); Shinji HASHIMOTO, Kariya-city (JP)

(21) Appl. No.: 17/110,584

(22) Filed: Dec. 3, 2020

Related U.S. Application Data
(63) Continuation of application No. PCT/JP2019/013582, filed on Mar. 28, 2019.

(30) Foreign Application Priority Data
Jun. 7, 2018 (JP) 2018-109450

(51) Int. Cl. B60H 1/32; F16H 25/20; F16H 49/00; F16K 27/00; F16K 31/04; F16K 31/44; F25B 41/06

(52) U.S. Cl. CPC B60H 1/32; F16H 25/20; F16H 49/00; F25B 41/06; F16K 31/04; F16K 31/44; F16K 27/00

(57) ABSTRACT

A valve device includes a valve that changes a flow state of refrigerant flowing in a circulation path of a refrigeration cycle device, and a drive device that drives the valve. The drive device includes an electric drive unit that drives the valve, a circuit board having a control circuit that controls a drive of the electric drive unit, and a detector that detects a state of the refrigerant. The electric drive unit, the circuit board and the detector are housed in a housing. The electric drive unit, the circuit board, and the detection body are electrically connected to each other inside the housing.

### CROSS REFERENCE TO RELATED APPLICATION

The present application is a continuation application of International Patent Application No. PCT/JP2019/013582 filed on Mar. 28, 2019, which designated the U.S. and claims the benefit of priority from Japanese Patent Application No. 2018-109450 filed on Jun. 7, 2018. The entire disclosures of all of the above applications are incorporated herein by reference.

### TECHNICAL FIELD

The present disclosure relates to an electric valve device having an electric drive unit.

### BACKGROUND

A refrigeration cycle device for a vehicle includes various valve devices, such as an expansion valve. A valve opening degree of the expansion valve is changed according to the situation in order to control a decompression state of refrigerant.

### SUMMARY

A valve device includes: a valve configured to change a flow state of refrigerant flowing through a circulation path of a refrigeration cycle device; and a drive device configured to drive the valve. The valve device is an electric valve device using an electric drive unit as a drive source of the drive device. The drive device includes: the electric drive unit; a circuit board having a control circuit configured to control a drive of the electric drive unit; and a detector configured to detect a state of the refrigerant. The electric drive unit, the circuit board, and the detector are housed in a housing and are electrically connected to each other inside the housing.

### BRIEF DESCRIPTION OF THE DRAWINGS

FIG. 1 is a schematic configuration diagram showing a refrigeration cycle device including a valve device according to an embodiment.

FIG. 2 is a schematic configuration diagram showing an expansion valve device.

FIG. 3 is an electrical block diagram showing an electrical configuration of the expansion valve device.

### DETAILED DESCRIPTION

To begin with, examples of relevant techniques will be described.

A refrigeration cycle device for a vehicle includes various valve devices, for example, an expansion valve. A valve opening degree of the expansion valve is changed according to the situation in order to control a decompression state of refrigerant.

In contrast to a mechanical expansion valve, the present inventors consider using an electric expansion valve device that uses an electric drive unit such as a motor. When electrifying the valve device, it is to be considered making a rational device configuration including the electric drive unit and the surrounding functional components.

The present disclosure provides an electric valve device having a rational device configuration including an electric drive unit and the surrounding functional components.

In one aspect of the present disclosure, a valve device includes a valve that changes a flow state of refrigerant flowing in a circulation path of a refrigeration cycle device, and a drive device that drives the valve. An electric drive unit is provided as a drive source of the drive device, such that the valve device is an electric valve device. The drive device includes an electric drive unit, a circuit board on which a control circuit is defined to control the electric drive unit, and a detector that detects a state of the refrigerant. The electric drive unit, the circuit board, and the detector are housed in a housing, and are electrically connected to each other inside the housing.

According to the above aspect, the drive device that drives the valve includes the electric drive unit, the circuit board on which the control circuit is mounted, and the detector that detects the state of the refrigerant. The electric drive unit, the circuit board, and the detector are housed in the housing, and are electrically connected to each other within the housing. The electric drive unit and the detector may be separate from each other, and the electric drive unit and the circuit board may be separate from each other, when the mechanical valve device is converted to the electric valve device. However, the electric drive unit, the circuit board, and the detector need to be electrically connected with each other, so that a waterproof structure including wires can be greatly simplified when the electric drive unit, the circuit board, and the detector are electrically connected inside the housing. Further, it is possible to reduce the number of wires and the need for wire routing design.

A valve device according to an embodiment will be described with reference to the drawings. In the drawings, a part of the configuration may be exaggerated or simplified for convenience of description. Also, the dimensional ratio of components may be different from the actual one.

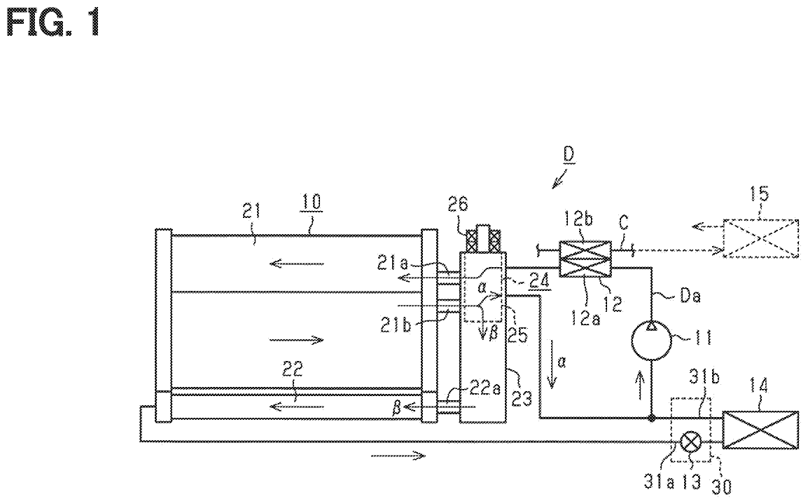

As shown in FIG. 1, a heat exchanger 10 of the present embodiment is used for a refrigeration cycle device D (heat pump cycle device) for air conditioning of an electric vehicle (such as hybrid vehicle or EV vehicle). An air conditioner for a vehicle includes the refrigeration cycle device D, and is configured to be switchable between a cooling mode in which air cooled by an evaporator 14 is blown into the vehicle cabin and a heating mode in which air warmed by a heater core 15 is blown into the vehicle cabin. A refrigerant circulation circuit Da of the refrigeration cycle device D is configured to be switchable between a circulation circuit corresponding to the cooling mode (cooling circulation path β) and a circulation circuit corresponding to the heating mode (heating circulation path α). The refrigerant circulated in the refrigerant circulation circuit Da of the refrigeration cycle device D is, for example, an HFC-based refrigerant or an HFO-based refrigerant. It is preferable that the refrigerant contains oil for lubricating a compressor 11.

The refrigeration cycle device D includes the compressor 11, a water-cooled condenser 12, the heat exchanger 10, an expansion valve 13 (expansion valve device 30), and the evaporator 14 in the refrigerant circulation circuit Da.

The compressor 11 is an electric compressor arranged in an engine room outside the vehicle cabin, and sucks and compresses gas-phase refrigerant, thereby heating the gas-phase refrigerant, to discharge toward the water-cooled condenser 12. The high-temperature and high-pressure vapor-phase refrigerant discharged from the compressor 11 flows into the water-cooled condenser 12. The compressor 11 may have various compression mechanism such as a scroll type compression mechanism and a vane type compression mechanism. Further, the compressor 11 is controlled in the refrigerant discharge capacity.

The water-cooled condenser 12 is a known heat exchanger, and includes a first heat exchange section 12a provided on the refrigerant circulation circuit Da and a second heat exchange section 12b provided on a circulation circuit C for cooling water in the cooling water circulation device. The heater core 15 is provided on the circulation circuit C. The water-cooled condenser 12 causes heat exchange between the vapor-phase refrigerant flowing in the first heat exchange section 12a and the cooling water flowing in the second heat exchange section 12b. That is, in the water-cooled condenser 12, the cooling water in the second heat exchange section 12b is heated by the heat of the vapor-phase refrigerant in the first heat exchange section 12a, while the vapor-phase refrigerant in the first heat exchange section 12a is cooled. Therefore, the water-cooled condenser 12 functions as a radiator that dissipates the heat of the refrigerant discharged from the compressor 11 to the first heat exchange section 12a to the blown air of the air conditioner via the cooling water and the heater core 15.

The gas-phase refrigerant that has passed through the first heat exchange section 12a of the water-cooled condenser 12 flows into the heat exchanger 10 via an integrated valve device 24. The heat exchanger 10 is an outdoor heat exchanger arranged on the front side of the vehicle in the engine room outside the vehicle cabin. In the heat exchanger 10, heat is exchanged between refrigerant flowing through the heat exchanger 10 and air (outside air) blown by a blower fan (not shown) outside the cabin.

Specifically, the heat exchanger 10 includes a first heat exchange section 21 and a second heat exchange section 22 that functions as a subcooler. Further, the heat exchanger 10 is integrally configured with a liquid reservoir 23 connected to the first heat exchange section 21 and the second heat exchange section 22, and the integrated valve device 24 provided in the liquid reservoir 23. The inflow path 21a and the outflow path 21b of the first heat exchange section 21 are in communication with the integrated valve device 24. Further, the inflow path 22a of the second heat exchange section 22 is in communication with the liquid reservoir 23 and the integrated valve device 24.

The first heat exchange section 21 functions as a condenser or an evaporator in response to the temperature of the refrigerant which circulates inside. The liquid reservoir 23 is configured to separate the vapor-phase refrigerant and the liquid-phase refrigerant, and the separated liquid-phase refrigerant is stored in the liquid reservoir 23. The second heat exchange section 22 further cools the liquid-phase refrigerant by exchanging heat between the liquid-phase refrigerant flowing from the liquid reservoir 23 and the outside air to increase the degree of supercooling of the refrigerant. After the heat exchange, the refrigerant flows into the expansion valve 13. The first heat exchange section 21, the second heat exchange section 22, and the liquid reservoir 23 are integrally configured by being connected to each other by, for example, bolt fastening.

The integrated valve device 24 includes a valve main body 25 arranged in the liquid reservoir 23 and an electric drive unit 26 that drives the valve main body 25. The electric drive unit 26 has a motor (for example, a stepping motor) such that the integrated valve device 24 is an electrically operated valve device. In the heating mode, a heating circulation path a is established in the integrated valve device 24, such that the first heat exchange section 12a of the water-cooled condenser 12 and the inflow path 21a of the first heat exchange section 21 are communicated with each other and that the outflow path 21b of the first heat exchange section 21 is directly communicated with the compressor 11. In the cooling mode, a cooling circulation path 13 is established in the integrated valve device 24, such that the first heat exchange section 12a of the water-cooled condenser 12 and the inflow path 21a of the first heat exchange section 21 are communicated with each other, and that the outflow path 21b of the first heat exchange section 21 is communicated with the compressor 11 via the second heat exchange section 22, the expansion valve 13 and the evaporator 14. The integrated valve device 24 closes all the flow paths at the stope time. In other words, the integrated valve device 24 operates the valve main body 25 by driving the electric drive unit 26, and switches the operation in response to the state of stop, heating mode, and cooling mode.

The expansion valve 13 is a valve configured to decompress and expand the liquid-phase refrigerant supplied from the heat exchanger 10. In the present embodiment, the expansion valve 13, which is a valve body, can be operated by an electric drive unit (motor) 42 so as to integrally configure an electric expansion valve device 30. The specific configuration of the expansion valve device 30 will be described later. The expansion valve 13 decompresses the low-temperature and high-pressure liquid-phase refrigerant and supplies the refrigerant to the evaporator 14.

The evaporator 14 is a cooling heat exchanger (evaporator) that cools the air in the cooling mode. The liquid-phase refrigerant supplied from the expansion valve 13 to the evaporator 14 exchanges heat with air around the evaporator 14 (in the duct of the air conditioner for a vehicle). Due to the heat exchange, the liquid-phase refrigerant is vaporized, and the air around the evaporator 14 is cooled. After that, the refrigerant in the evaporator 14 flows out toward the compressor 11 and is compressed again in the compressor 11.

Next, a specific configuration of the expansion valve device 30 of the present embodiment will be described.

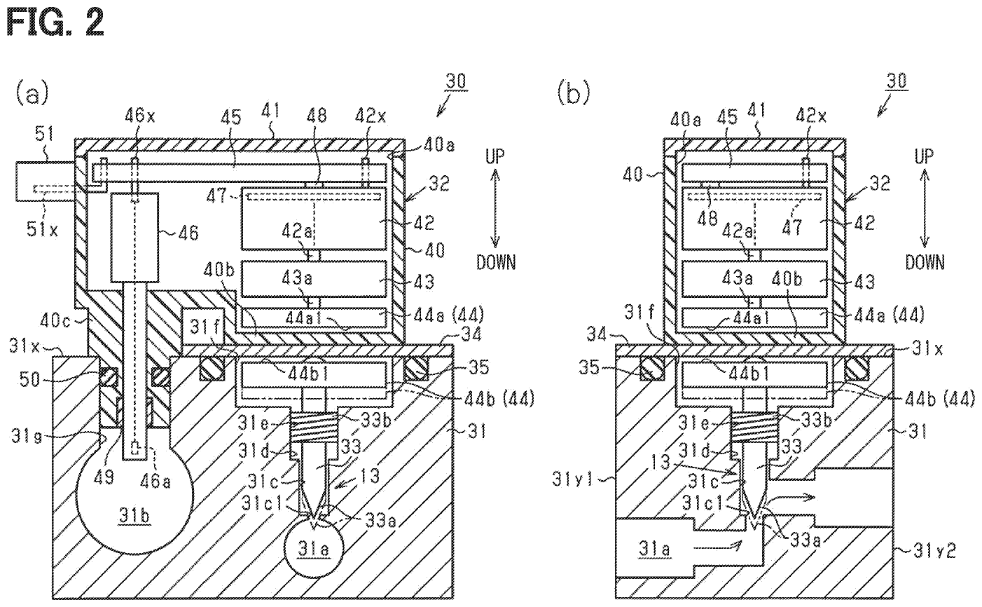

As shown in (a) and (b) of FIG. 2, the expansion valve device 30 includes the expansion valve 13 defined in a base block 31 and the drive device 32 integrally fixed to the base block 31 to drive the expansion valve 13.

An inflow passage 31a and an outflow passage 31b are arranged in the base block 31 of the expansion valve device 30. The refrigerant flows from the second heat exchange section 22 toward the evaporator 14 through the inflow passage 31a. The refrigerant flows from the evaporator 14 toward the compressor 11 through the outflow passage 31b. The inflow passage 31a and the outflow passage 31b extend substantially parallel to each other. Each of the inflow passage 31a and the outflow passage 31b has a circular cross-section as a passage shape. The base block 31 has a substantially rectangular parallelepiped shape. When the drive device 32 is fixed on an upper surface 31x of the base block 31 (hereinafter, for description, the base block 31 is located at the lower side, and the drive device 32 is located at the upper side), the inflow passage 31a and the outflow passage 31b are formed to penetrate the base block 31 from one side surface 31y1 toward the other side surface 31y2 on the opposite side.

A vertical passage 31c is provided in the middle of the inflow passage 31a of the base block 31 to extend in the up-down direction orthogonal to the extending direction of the base block 31. A valve body 33 is housed in a valve housing hole 31d of the base block 31 communicated with an upper side of the vertical passage 31c. The valve housing hole 31d has a circular shape in the cross section. The valve body 33 is a needle-shaped valve element having a tip end 33a sharpened downward, such that the expansion valve 13 is formed of a needle valve. That is, when the valve body 33 moves forward and backward along its axial direction (up-down direction in FIG. 2), the tip end 33a opens and closes the opening 31c1 of the vertical passage 31c. Thus, the flow of the refrigerant to the inflow passage 31a is allowed or blocked, and the flow rate is adjusted.

The valve body 33 includes a male thread 33b at an intermediate portion and a driven-side rotating body 44b, which configures a magnetic coupling (magnet coupling) 44, at a base end portion, in addition to the tip end 33a. The male thread 33b is engaged with a female thread 31e formed on the inner peripheral surface of the valve housing hole 31d, so that the rotation of the valve body 33 can be directly converted in linear motion in the axial direction (vertical direction) of the valve body 33 itself. The driven-side rotating body 44b is coaxially fixed to the base end portion of the valve body 33, and forms the magnetic coupling 44 with a driving-side rotating body 44a described later. That is, the driving-side rotating body 44a and the driven-side rotating body 44b are magnetically coupled in a non-contact manner. When the driven-side rotating body 44b is rotated by the rotation of the driving-side rotating body 44a, the rotational movement of the valve body 33 is converted into linear motion in the axial direction of the valve body 33 by the male thread 33b and the female thread 31e, that is, to open/close the passage with the expansion valve 13.

A closing plate 34 is fixed on the upper surface 31x of the base block 31 to close an opening 31f of the valve housing hole 31d. The closing plate 34 is made of metal (for example, SUS) and has a flat plate shape. An annular seal ring 35 is provided between the closing plate 34 and the upper surface 31x of the base block 31 so as to surround the opening 31f. That is, the opening 31f of the base block 31 is liquid-tightly closed by the closing plate 34 and the seal ring 35 to seal the base block 31, so that the refrigerant does not leak outside (for example, toward the drive device 32).

The drive device 32 is fixed on the upper surface 31x of the base block 31 with, for example, a mounting screw (not shown) in a manner that the closing plate 34 is partially interposed between the drive device 32 and the base block 31. The drive device 32 includes a housing 40 having an opening 40a on the upper surface and a cover 41 that closes the opening 40a of the housing 40. The housing 40 houses the electric drive unit 42, the speed reduction unit 43, the driving-side rotating body 44a of the magnetic coupling 44, the circuit board 45, and the temperature/pressure detector 46.

In the drive device 32, the electric drive unit 42, the speed reduction unit 43, and the driving-side rotating body 44a of the magnetic coupling 44 are provided coaxially with the valve body 33 (driven-side rotating body 44b) of the expansion valve 13. The speed reduction unit 43 is disposed below the electric drive unit 42. The driving-side rotating body 44a of the magnetic coupling 44 is disposed below the speed reduction unit 43.

The electric drive unit 42 includes, for example, a stepping motor, a brushless motor, or a brush motor. The electric drive unit 42 has its own connection terminals 42x connected to the circuit board 45, and receives power supply from the circuit board 45 via the connection terminals 42x. The electric drive unit 42 is driven by the power supply from the circuit board 45 (control circuit) to rotate the rotary shaft 42a. Further, the electric drive unit 42 includes a detected object (sensor magnet) 47 that rotates integrally with the rotary shaft 42a. The position detector (Hall IC) 48 of the circuit board 45 detects the detected object 47 to obtain the rotation information (rotation position, speed, etc.) of the rotary shaft 42a. The rotary shaft 42a of the electric drive unit 42 projects from the lower side of the main body and is connected to the speed reduction unit 43.

The speed reduction unit 43 is configured by, for example, a reduction gear mechanism using plural gears. The speed reduction unit 43 decelerates the rotation of the rotary shaft 42a of the electric drive unit 42 and increases the torque to output the rotation from the output shaft 43a. The output shaft 43a projects from the lower side of the speed reduction unit 43, and the driving-side rotating body 44a of the magnetic coupling 44 is coaxially fixed to the tip end of the output shaft 43a.

The magnetic coupling 44 includes the driving-side rotating body 44a and the driven-side rotating body 44b, which are arranged coaxially with each other. The driving-side rotating body 44a has a magnetic facing surface 44a1 facing the bottom portion 40b of the housing 40. The driven-side rotating body 44b has a magnetic facing surface 44b1 facing the closing plate 34. In other words, the bottom portion 40b of the housing 40 and the closing plate 34 overlapping with each other are interposed between the driving-side rotating body 44a and the driven-side rotating body 44b. That is, the driving-side rotating body 44a and the driven-side rotating body 44b capable of rotating are configured such that the magnetic facing surfaces 44a1 and 44b1 are magnetically coupled to each other while the bottom portion 40b of the housing 40 and the closing plate 34 are interposed between the driving-side rotating body 44a and the driven-side rotating body 44b.

The internal space of the housing 40 housing the driving-side rotating body 44a and the internal space of the base block 31 housing the driven-side rotating body 44b are liquid-tightly partitioned by the closing plate 34 (the bottom portion 40b of the housing 40). That is, the driven-side rotating body 44b is arranged in the space where the refrigerant exists, while the driving-side rotating body 44a is arranged in the space which is separated from the space where the refrigerant exists. In this case, in addition to the driving-side rotating body 44a, the speed reduction unit 43, the electric drive unit 42, the circuit board 45, and the temperature/pressure detector 46 are also arranged in the space that is liquid-tightly separated from the space in which the refrigerant exists, so as to restrict the infiltration of the refrigerant into the housing 40.

The circuit board 45 is arranged adjacent to the opening 40a of the housing 40 at the upper side of the electric drive unit 42. Various electronic components (not shown) are mounted on the circuit board 45, to form a control circuit that drives and controls the electric drive unit 42. The circuit board 45 is arranged such that its plane direction is along a direction orthogonal to the axial direction of the electric drive unit 42, and is arranged so as to straddle the electric drive unit 42 and the temperature/pressure detector 46.

The temperature/pressure detector 46 is connected to the circuit board 45. The temperature/pressure detector 46 has a shape that is long in one direction, and is arranged such that its longitudinal direction is along the vertical direction. That is, the longitudinal direction of the temperature/pressure detector 46 is parallel to the axial direction of the electric drive unit 42. The temperature/pressure detector 46 is arranged such that at least the detection surface of the sensor IC 46a is exposed from the tip end (lower end), and that one end of the connection terminal 46x projects outward from the base end portion (upper end). The other parts of the temperature/pressure detector 46 are molded with resin. The temperature/pressure detector 46 may include a processing IC or the like for processing the signal from the sensor IC 46a inside the mold portion.

The temperature/pressure detector 46 is held by the housing 40 by being inserted in a support cylinder 40c of the housing 40 protruding downward from the bottom portion 40b. The electric drive unit 42 is arranged above the inflow passage 31a (above the expansion valve 13) of the base block 31, and the temperature/pressure detector 46 is disposed above the outflow passage 31b of the base block 31. The support cylinder 40c is fitted in a sensor mounting hole 31g communicating with the outflow passage 31b of the base block 31. The lower end of the temperature/pressure detector 46 protrudes from the tip end (lower end) of the support cylinder 40c. In other words, the sensor IC 46a at the lower end of the temperature/pressure detector 46 is located in the outflow passage 31b of the base block 31 when the support cylinder 40c is attached to the sensor mounting hole 31g.

A sealing material 49 is provided between the outer side surface of the temperature/pressure detector 46 and the inner side surface of the support cylinder 40c, at a location slightly upper than the position of the sensor IC 46a of the temperature/pressure detector 46. The sealing material 49 liquid-tightly partitions a space in the outflow passage 31b of the base block 31 and a space in the housing 40 including the support cylinder 40c, so that the refrigerant flowing in the outflow passage 31b is restricted from entering the housing 40. An annular seal ring 50 is attached on the outer side surface of the support cylinder 40c so as to surround itself. The seal ring 50 is interposed between the support cylinder 40c and the inner side surface of the sensor mounting hole 31g. The seal ring 50 restricts the refrigerant flowing in the outflow passage 31b from leaking from the base block 31 to the outside.

Each of the connection terminals 46x at the upper end of the temperature/pressure detector 46 is electrically connected to the circuit board 45. The sensor IC 46a detects the temperature and/or pressure of the refrigerant flowing in the outflow passage 31b, and the temperature/pressure detector 46 outputs each detection signal from the sensor IC 46a to the circuit board 45 via the connection terminal 46x.

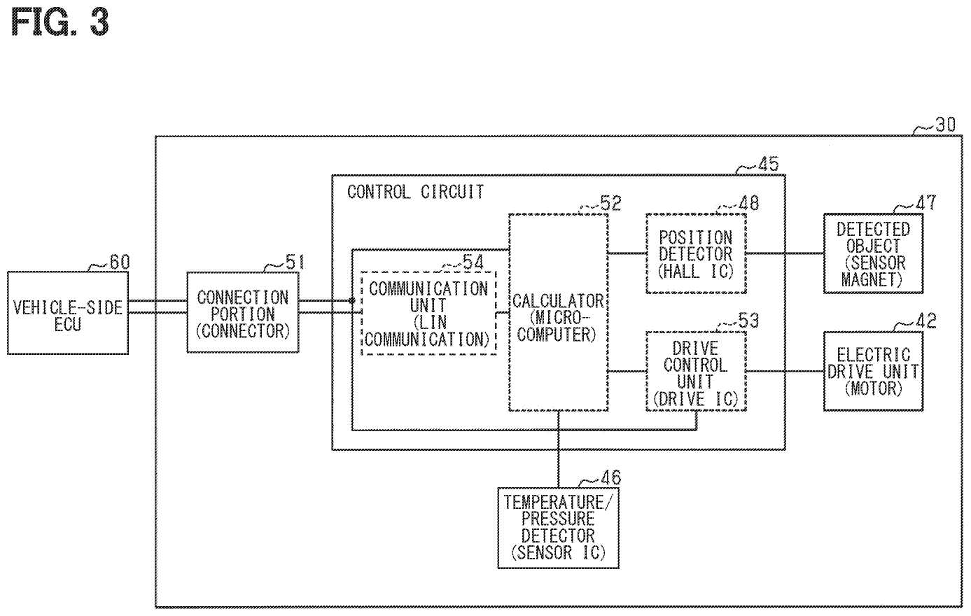

A connection portion (connector) 51 is integrally provided on a side surface of the housing 40 near the opening 40a to be electrically connected to the vehicle-side ECU 60 (see FIG. 3). The connection portion 51 has plural connection terminals 51x, and each connection terminal 51x is electrically connected to the circuit board 45.

As shown in FIG. 3, the control circuit of the circuit board 45 includes a calculator (microcomputer) 52, a drive control unit (drive IC) 53, a communication unit 54, and the position detector 48. The control circuit of the circuit board 45 receives power supply from the vehicle-side ECU 60 via the connection portion 51. The control circuit of the circuit board 45 supplies the operating power supply to the calculator 52 and the drive power supply to the electric drive unit (motor) 42 via the drive control unit 53. The control circuit of the circuit board 45 uses, for example, the communication unit 54 capable of LIN (Local Interconnect Network) communication. The vehicle-side ECU 60 and the calculator 52 exchange signals via the connection portion 51, and the calculator 52 obtains a command from the vehicle-side ECU 60.

The calculator 52 detects the temperature and pressure of the refrigerant flowing out from the evaporator 14 based on the detection signal from the temperature/pressure detector 46 (sensor IC 46a). Further, the calculator 52 obtains rotation information (rotation position, speed, etc.) of the rotary shaft 42a of the electric drive unit 42 through the position detector (Hall IC) 48 and the detected object (sensor magnet) 47. Then, the calculator 52 calculates using the command from the vehicle-side ECU 60, the temperature and pressure of the refrigerant, and the rotation information of the electric drive unit 42, and sets and outputs an appropriate control signal for each time to the drive control unit 53. The drive control unit 53 supplies the drive power based on the control signal each time, and controls the rotation of the electric drive unit 42.

In this way, the control circuit of the circuit board 45 controls the rotation of the electric drive unit 42, and adjusts the advancing/retreating position of the valve body 33 of the expansion valve 13 via the speed reduction unit 43 and the magnetic coupling 44, so as to control the supply of refrigerant to the evaporator 14. That is, the control circuit of the circuit board 45 controls the opening/closing of the expansion valve 13 (expansion valve device 30) that is interlocked with the integrated valve device 24 of the air conditioner for a vehicle, such that the air conditioning control is performed together with the control circuit that controls the integrated valve device 24.

The effects of the present embodiment will be described.

According to the drive device 32 of the present embodiment, the housing 40 houses the electric drive unit (motor) 42, the circuit board 45 having the control circuit, and the temperature/pressure detector 46 configured to detect the state (temperature and pressure) of the refrigerant. The electric drive unit 42, the circuit board 45, and the temperature/pressure detector 46 are electrically connected to each other inside the housing 40. In case where the mechanical valve device is electrified, the electric drive unit and the detector may be separate from each other, and the electric drive unit and the circuit board may be separate from each other. However, the electric drive unit, the circuit board, and the detector need to be electrically connected. Therefore, like the drive device 32 of the present embodiment, the electric drive unit 42, the circuit board 45, and the temperature/pressure detector 46 are electrically connected inside the housing 40, thereby providing a rational configuration simplified in the waterproof structure including the electric wires, since it is possible to reduce the number of electric wires and the route design of the electric wires. In this way, the expansion valve device 30 used in the refrigeration cycle device D for a vehicle can be an electrically operated valve device having a rational device configuration.

The drive device 32 is integrally fixed to the base block 31 that houses the expansion valve 13 and has the inflow passage 31a and the outflow passage 31b, which are a part of the circulation path of the refrigeration cycle device D, as a unit. Therefore, the assembling of the expansion valve device 30 can be made accurately and easily.

While the drive device 32 is integrally fixed on the base block 31, the expansion valve 13 housed in the base block 31 can be driven by the electric drive unit 42. The temperature/pressure detector 46 can detect the state of the refrigerant flowing through the circulation path in the base block 31.

In the housing 40, the circuit board 45 is (adjacent to the opening 40a) more distant from the base block 31 having the circulation path of the refrigerant than the electric drive unit 42 and the temperature/pressure detector 46 are. In the present embodiment in which the circuit board 45 is located at the upper side, even if refrigerant enters the housing 40, the refrigerant is restricted from reaching the circuit board 45, thereby suppressing damage of the circuit board 45.

Since the temperature/pressure detector 46 is a resin-molded integrated component including the sensor IC 46a and the connection terminal 46x, it is easy to handle the temperature/pressure detector 46 and easy to assemble the temperature/pressure detector 46 to the drive device 32.

The temperature/pressure detector 46 has a component shape that is long in one direction. The drive device 32 can be made compact by arranging the longitudinal direction of the temperature/pressure detector 46 is parallel to the arrangement direction of the electric drive unit 42 and the expansion valve 13 (the axial direction of the electric drive unit 42).

Since the circuit board 45 is arranged so as to straddle the electric drive unit 42 and the temperature/pressure detector 46, the electrical connection therebetween can be easily and efficiently performed.

The magnetic coupling 44 is provided at a transmission path between the electric drive unit 42 and the expansion valve 13, to liquid-tightly partition the driving-side rotating body 44a of the drive device 32 (electric drive unit 42) and the driven-side rotating body 44b of the base block 31 (expansion valve 13). Therefore, it is possible to more reliably restrict the infiltration of the refrigerant into the drive device 32 through the transmission path that tends to be the infiltration path of the refrigerant. Further, since the driving-side rotating body 44a and the driven-side rotating body 44b of the magnetic coupling 44 attract each other, the rattling of the valve body 33 of the expansion valve 13, which is moved forward and backward by the thread mechanism, can be suppressed in the forward direction.

The refrigeration cycle device D is to be mounted on a vehicle. Therefore, the valve device used in the refrigeration cycle device for a vehicle can be provided as an electric valve device having a rational device configuration.

According to the present disclosure, the valve device can be provided as an electric valve device having a rational device configuration including the electric drive unit and the peripheral functional components.

This embodiment can be modified and implemented as follows. The above described embodiment and the following modifications can be implemented in combination with one another as long as there is no technical contradiction.

While a motor (stepping motor, brushless motor, brush motor, or the like) is used as the electric drive unit 42, an electric drive unit other than the motor, such as an electromagnetic solenoid, may be used as the electric drive unit 42.

The circuit board 45 is not limited to be arranged near the opening 40a of the housing 40. The circuit board 45 is not limited to be arranged above the electric drive unit 42 and the temperature/pressure detector 46. The circuit board 45 is not limited to be arranged across the electric drive unit 42 and the temperature/pressure detector 46. For example, the circuit board 45 may be arranged closer to the electric drive unit 42 or the temperature/pressure detector 46. Further, the circuit board 45 may be arranged such that the plane direction of the circuit board 45 is along the vertical direction. In this case, the circuit board 45 may be arranged along the side surface of the housing 40.

The temperature/pressure detector 46 is capable of detecting both the temperature and the pressure of the refrigerant. The detector 46 may be capable of detecting either the temperature or the pressure of the refrigerant. The detector 46 may detect the other state (flow rate or flow velocity) of the refrigerant other than the temperature and the pressure.

The speed reduction unit 43 is configured by a reduction gear mechanism using plural gears. However, the speed reduction unit 43 is not only a mechanical reduction gear mechanism such as a gear train and a planetary gear, but also a magnetic mechanism that can be configured together with the magnetic coupling 44. Further, the speed increasing mechanism may be used instead of the speed reduction mechanism. Further, the speed reduction or increasing mechanism may be omitted.

The magnetic coupling 44 is used to connect the electric drive unit 42 and the expansion valve 13, but the magnetic coupling 44 may not be used. For example, a general drive coupling structure may be used in which a shaft passes through the housing 40.

While the valve body 33 of the expansion valve 13 is composed of a needle valve which operates in its own axial direction, a valve structure other than the needle valve may be used as the valve body 33.

The base block 31 is located at the lower side and the drive device 32 is located at the upper side. However, the arrangement structure is not limited to this, and may be appropriately changed.

The expansion valve device 30 is made as one unit integrally including the base block 31 and the drive device 32, but the base block 31 and the drive device 32 may be configured separately.

The present disclosure may be applied to valves other than the expansion valve device 30 (expansion valve 13). For example, the present disclosure may be applied to the integrated valve device 24 in the refrigeration cycle device D of the above embodiment.

The present disclosure is applied to the refrigeration cycle device D that conditions air in a vehicle. Alternatively, the present disclosure may be applied to the other refrigeration cycle device that conditions air not for a vehicle. For example, the present disclosure may be applied to a refrigeration cycle device for cooling a battery. The present disclosure may be applied to a valve device used on a refrigerant circulation path of the other refrigeration cycle device.

What is claimed is:

1. A valve device comprising:
a valve configured to change a flow state of refrigerant flowing through a circulation path of a refrigeration cycle device; and
a drive device configured to drive the valve, wherein the valve device is an electric valve device using an electric drive unit as a drive source of the drive device, wherein
the drive device includes
the electric drive unit,
a circuit board having a control circuit configured to control a drive of the electric drive unit; and
a detector configured to detect a state of the refrigerant, and
the electric drive unit, the circuit board, and the detector are housed in a housing and are electrically connected to each other inside the housing.

2. The valve device according to claim 1, further comprising
a base block housing the valve, a part of the circulation path of the refrigeration cycle device is defined by the base block, wherein
the drive device is integrally fixed to the base block,
the electric drive unit is able to drive the valve housed in the base block, and
the detector is able to detect a state of the refrigerant flowing in the circulation path formed in the base block.

3. The valve device according to claim 1, wherein the circuit board is positioned farther from the circulation path than the electric drive unit and the detector are inside the housing.

4. The valve device according to claim 1, wherein the detector is formed of a resin-molded integrated component including a detection element and a connection terminal.

5. The valve device according to claim 4, wherein the detector has a shape elongated in one direction, and is arranged such that a longitudinal direction of the detector is parallel to an arrangement direction of the electric drive unit and the valve.

6. The valve device according to claim 5, wherein the circuit board is arranged so as to overlap with the electric drive unit and the detector.

7. The valve device according to claim 1, further comprising
a magnetic coupling disposed on a drive transmission path between the electric drive unit and the valve, wherein
the magnetic coupling has a driving-side rotating body arranged to face the drive device,
the magnetic coupling has a driven-side rotating body arranged to face a base block that houses the valve, and
a space between the driving-side rotating body and the driven-side rotating body is liquid-tightly partitioned.

8. The valve device according to claim 1, wherein the refrigeration cycle device is to be mounted on a vehicle.
